(19) United States
(12) Patent Application Publication
(10) Pub. No.: US 2007/0237955 A1
(43) Pub. Date: Oct. 11, 2007

(54) Hydrofluorocarbon polymer compositions for scrape abrasion resistant articles

(76) Inventors: Daniel A. Favereau, Chambesy (CH); Kimberly Dawn Farnsworth, Walker, WV (US); Anthony J. Pasquale, Parkersburg, WV (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/809,865

(22) Filed: Jun. 1, 2007

Related U.S. Application Data
(63) Continuation of application No. 11/000,714, filed on Dec. 1, 2004, now abandoned.
(60) Provisional application No. 60/528,111, filed on Dec. 9, 2003.

(51) Int. Cl. B32B 27/00; C09K 5/00

(52) U.S. Cl. 428/383; 252/67

(57) ABSTRACT

Articles made from blends of hydrofluorocarbon polymer such as copolymer of ethylene and tetrafluoroethylene, with boron nitride show improved scrape abrasion resistance.

### FIELD OF THE INVENTION

This invention relates to hydrofluorocarbon polymer wire insulation having improved physical properties.

### BACKGROUND OF THE INVENTION

Electrical wiring in vehicles is subject to high temperature and to mechanical abrasion caused by engine vibration and vehicle motion. Abrasion of insulation ultimately leads to short circuits and electrical failure. Fluoropolymers are often selected as wire insulation because of their good high temperature and chemical resistance. Among fluoropolymers, are the hydrofluorocarbon polymers, the most common of which are the copolymers of ethylene and tetrafluoroethylene (ETFE), which have generally better physical properties, including abrasion resistance, and are chosen for more demanding service than the melt-fabricable perfluorocarbon polymers. Further improvement in ETFE abrasion resistance can be achieved by crosslinking the ETFE. However, as disclosed in U.S. Pat. No. 5,059,483, crosslinked polymer is subject to failure if flexed after the insulation surface is cut, nicked, or otherwise damaged. According to the patent, this weakness can be mitigated at the cost of greater complexity through use of an inner uncrosslinked layer and an outer crosslinked layer. An alternative approach is the use of thicker insulation at the penalty of stiffer, less flexible wire.

In the future, vehicles are expected to have more wiring as electronics are increasingly adopted and mechanical systems, such as steering and braking mechanisms, are replaced by electrical. Temperature rating under car hoods in increasing due to better engine management combined with improved noise absorption. Such vehicles will need high temperature wiring with improved abrasion resistance without sacrifice of flexibility. Improved abrasion resistant compositions will find utility in other industries such as aerospace, and appliances and also other applications such as tubing and push-pull cables.

### SUMMARY OF THE INVENTION

The present invention provides an insulated wire, the insulation of which is unfoamed and extrusion coated on said wire, said insulation comprising hydrofluorocarbon polymer and an effective amount of boron nitride (BN) for improving the scrape abrasion resistance of said coating of said composition on said wire, said amount being ineffective to increase the rate of said extrusion to form said coating. Surprisingly, only a small amount of BN is required in the hydrofluorocarbon polymer to obtain a great improvement in the scrape abrasion resistance of the insulation, and this small amount, e.g. no greater than 1 wt %, generally does not have any significant adverse effect on quality of the insulation and preferably no significant adverse effect on the extrusion rate as compared to the extrusion rate for the polymer by itself. The improvement in scrape abrasion resistance can be characterized by the insulation resisting at least 200 scrape abrasion cycles when subjected to scrape abrasion testing by the procedure in ISO 6722 at a load of 7 N. The improvement can also be characterized by the percent improvement in scrape abrasion resistance imparted to the hydrofluorocarbon polymer by the BN additive, namely an improvement of at least 100%, preferably at least 200%, and more preferably at least 300% as compared to the hydrofluorocarbon polymer by itself, as measured by the procedure of ISO 6722 at a load of 7 N.

Another embodiment of the present invention is the ultra-thin insulation that is enabled by the improved scrape abrasion resistance in the embodiment described above, i.e. this improvement enables the insulation to be very thin and still be usable in applications in which the insulation is subjected to scrape abrasion, such as occurs when the insulated wire is pulled through apertures in framing that establish the pathway and positioning of the insulated wire in the particular product, e.g. automobile, appliance, or airplane, in which the insulated wire is used. In this embodiment, the insulation is no more than 6 mils (0.15 mm) thick, and in addition to the improved scrape abrasion resistance, the presence of the BN in the insulation does not detract from the required electrical strength and stress crack resistance of the insulation for this ultra-thin insulation and for thicker insulation as well.

### DETAILED DESCRIPTION

The preferred hydrofluorocarbon polymer used in the present invention is ETFE. The polymer referred to herein as ETFE is a copolymer of ethylene, tetrafluoroethylene (TFE), and at least one other monomer such as perfluorobutyl ethylene (CH₂═CH(C₄F₉) or PFBE), hexafluoroisobutylene (CH₂═C(CF₃)₂) or HFIB), perfluoro(alkyl vinyl ether) (PAVE), or hexfluoropropylene (HFP). This third monomer, the termonomer, is present up to about 10 wt % of the total polymer weight. The molar ratio of ethylene to TFE is in the range of about 30:70 to 70:30, preferably about 35:65 to 65:35, and more preferably about 40:60 to 60:40. The melt flow rate (MFR) of the polymer as determined according to ASTM D 3159 which refers to D 1238, is from about 2 g/10 min to 50 g/10 min, preferably about 5 g/10 min to about 45 g/10 min, more preferably about 10 g/10 min to 40 g/10 min and most preferably about 25 g/10 min to 40 g/10 min. ETFE polymer is described in U.S. Pat. No. 4,123,602. Other well known hydrofluorocarbon polymers that can be used in the present invention in place of ETFE are polyvinylidene fluoride (PVDF) and ethylene/chlorotrifluoroethylene (ECTFE), with ETFE being preferred because of its best combination of abrasion resistance. Thus, the hydrofluorocarbon polymers used in the present invention have repeat —CH₂ —and —CF₂ —units in the polymer chain and preferably have repeat —CH₂—CH₂ —units in the polymer chain.

The boron nitride (BN) of the present invention is a product of Saint-Gobain Ceramics, Amherst New York USA. One preferred type of boron nitride is the lamellar, also known as graphitic, form. Preferred grades are UHP, more preferred are UHP500 Available from Saint Gobain Ceramics. The average particle size of the BN is from about 0.10 μm to 100 μm, preferably from about 0.5 μm to 50 μm, and more preferably from about 2 μm to 10 μm.

The weight % of BN in the hydrofluorocarbon polymer, based on combined weight of BN and hydrofluorocarbon polymer, is at least about 0.01, preferably at least about 0.05, more preferably at least about 0.1, and most preferably at least about 0.2. The weight % of BN in the hydrofluorocarbon polymer should be no greater than about 1, preferably no greater than about 0.9, more preferably no greater than about 0.75, and most preferably no greater than about 0.6. Thus, the preferred range of BN in the hydrofluorocarbon polymer is about 0.2 to 0.6 wt %. As the proportion of BN increases from the maximum amounts of 0.6 wt % and 1 wt %, depending on the particular hydrofluorocarbon polymer and BN used, the extrusion rate for extrusion forming of the insulation from the polymer has to be decreased in order to avoid the formation of surface roughness on the exterior surface of the extruded insulation.

The use of boron nitride as an extrusion aid in thermoplastic polymers such as polyethylene, and in fluoropolymers, is claimed in U.S. Pat. No. 5,688,457. Exemplified are copolymers of TFE and hexafluoropropylene (TFE/HFP, also known as FEP), but use with ETFE is suggested. Surprisingly, it has been discovered that boron nitride in ETFE at concentrations that are insufficient to positively affect (increase) extrusion rate is effective at improving scrape abrasion resistance. The maximum extrusion rate before roughness is visible on the surface of the extrudate is about the same whether or not the boron nitride is present in the ETFE copolymer, except as stated above, an excessive amount of BN requires the extrusion rate to be decreased in order to avoid surface roughness. ECTFE is also suggested in U.S. Pat. No. 5,688,457, and the proportion of BN used in this polymer as well as in PVDF to improve scrape abrasion resistance is also ineffective to increase the extrusion rate for this polymer.

The extrusion of the composition of the present invention is not accompanied by the presence of any foaming agent such as nitrogen injected into the extruder or foamable compound added to the composition, whereby the extruded wire insulation is unfoamed. No foaming agent is present in the composition. Thus the use of the hydrofluorocarbon polymer/boron nitride composition to make unfoamed wire insulation in an extrusion process to which the boron nitride does not contribute rate improvement, is a new use for such composition.

Boron nitride may be combined with the hydrofluorocarbon polymer by dry blending, such as by shaking the BN powder with hydrofluorocarbon polymer pellets in a container. This dry blend may be added directly to the melt processing equipment that produces the finished article of hydrofluorocarbon polymer+BN, such as an extruder for coating wire. Alternatively, the hydrofluorocarbon polymer and BN may be melt blended to produce pellets of hydrofluorocarbon polymer+BN, which then are processed to make the desired article, such as wire coating to form insulated wire. The melt blended hydrofluorocarbon polymer+BN pellets may be made using more BN than desired in the finished article, making what is known as concentrate. This concentrate may then be melt processed with additional hydrofluorocarbon polymer to “let down” the BN to the concentration effective for improved scrape abrasion resistance in the finished article.

The wire insulation according to this invention is from about 3 to 20 mils (0.075-0.5 mm) thick, preferably about 5 to 15 mils (0.125-0.375 mm) thick, and more preferably for general application, 8 to 12 mils (205-305 μm). For ultra-thin insulation thickness, however, the insulation thickness, will be from 4 mils to 6 mils (0.1 mm to 0.15 mm). The wire in these ultra-thin insulation wires will generally be from 18-22 gauge wire (40.3-25.3 mils (1.02-0.64 mm)).

### EXAMPLES

The scrape abrasion tests used herein are described in MIL W 583 (Test Instrument A) and ISO 6722 (Test Instrument B).

In Test Instrument A, the test rig is a Repeated Scrape Abrasion Tester, modified with a hardened tungsten-carbide blade, 0.027″ (686 μm) thick and 0.543″ (13.8 mm) wide with two 90° edges using a 4.5 N load. Four samples are tested and the average of the four measurements are reported.

Test Instrument B differs from Test Instrument A principally in having a needle in place of the blade. The use of Test Instrument B at a load of 7 N on the needle applies a more severe scrape abrasion to the insulated wire than Instrument A, and for this reason, the Instrument B (ISO 6722) test results are more relied upon by the automotive and aerospace industries using the insulated wire for the evaluation of scrape abrasion resistance.

The ETFE used in the Examples is Tefzel®, sold by the DuPont Company, Wilmington Del. USA. Polymer used is 15 wt % (39.5 mol %) ethylene, 80 wt % (59 mol %) TFE, and 5 wt % (1.5 mol %) PFBE. MFR=7 g/10 min. (MFR is melt flow rate, determined according to ASTM D-3159, which refers to ASTM D-1238.) The extruder used is a 30/D 45 mm. The extrusion line used is suitable for the processing of fluoropolymer resins, including corrosion resistant metal when in contact with the molten polymer, as well as high temperature processing capability <300° C. The extruder is fitted with a wire coating apparatus generally like that described in U.S. Pat. No. 5,688,457. A draw-down ratio of 28:1 is used for producing all the samples.

### Comparative Example 1

Tinned copper wire, 22 ga, is coated with ETFE alone at a thickness of 0.098 mils (250 μm). The temperature of the polymer at the die exit is between 325 to 351° C. Wires are produced at a line speeds between 100 up-to 510 m/min. Results of the Test Instrument A scrape abrasion test on this insulated wire are summarized in Table 1.

### Examples 1 to 3

The conditions of Comparative Example 1 are repeated using blends of ETFE with boron nitride, grade UHP-500, at BN concentrations of 0.05, 0.1, and 0.5 wt %. The mean particle size of the BN is 6 μm. The wire insulation is subjected to the scrape abrasion test of Instrument A. Results are summarized in Table 1. It is seen that the scrape abrasion resistance is more than doubled with 0.05 wt % BN and is still greater at higher loadings. As the BN loading increases above 0.5 wt %, the extrusion rate for the resulting composition has to be gradually reduced to avoid the formation of roughness on the surface of the wire insulation.

Attempts to increase the extrusion rate of these ETFE+BN blends to greater than that achieved with ETFE alone in Comparative Example 1 are unsuccessful. This shows that the boron nitride concentrations of Examples 1, 2, and 3 are insufficient to positively affect extrusion rate. That is, boron nitride is not acting as an extrusion aid at these concentrations in ETFE.

TABLE 1

| | Boron | |
|---|---|---|
| | Nitride | Scrape Abrasion |
| Examples | wt % | Cycles to Failure |
| Comp. Ex. 1 | 0 | 800-1700 |
| Example 1 | 0.05 | 2500-3500 |
| Example 2 | 0.1 | 4000-5000 |
| Example 3 | 0.5 | 8000-10000 |

Cycles to failure are reported when the blade has worn the entire insulation thickness down to the bar copper conductor. The test rig is then automatically stopped and the value is reported. The cycles to failure is the scrape abrasion resistance of the article being tested.

### Example 4

Insulated wire made in accordance with the procedure of Comparative Example 1 of the compositions of ETFE used in Example 1 and the additive mentioned in Table 2 below are tested on Test Instrument B at 7 N loading. Results are summarized in Table 2. Test Instrument B is more severe, but the superiority of boron nitride as an additive over the other additives to improve scrape abrasion resistance of the insulation is plain. It is about 4× better than the control, ETFE without additive. The effect of other additives is deleterious, reducing scrape abrasion resistance.

TABLE 2

| Additive 0.5 wt % | Cycles to Failure (7 N) |
|---|---|
| None | 82 |
| BN | 352 |
| Talc | 78 |
| ZnO | 54 |
| SiC | 43 |
| TiO2 | 70 |
| Fumed SiO₂ | 48 |
| Al₂O₃ | 42 |

Cycles to failure is the number of cycles before the needle reaches the wire of the insulated wire being tested and this is the scrape abrasion resistance in accordance with the procedure of ISO 6722 at the load indicated.

When perfluorocarbon polymers, FEP and PFA (copolymers of tetrafluoroethylene with hexafluoropropylene and perfluoro(alkyl vinyl ether), respectively), are substituted for the ETFE of the ETFE+0.5 wt % BN composition, the scrape abrasion resistance of the resultant composition is poor, i.e. less than 16 cycles.

It will be recognized that the improved scrape abrasion resistance the hydrofluorocarbon polymer/boron nitride composition confers on wire insulation made from it will be useful in any unfoamed article melt fabricated from compositions of the hydrofluorocarbon polymer plus boron nitride, such as by extrusion, injection molding, or compression molding, in which improved scrape abrasion resistance is desirable. Hoses and tubing used as push-pull cables or off-shore umbilicals, are examples. As in the case of extruding the composition to make insulated wire, when the melt fabrication is extruding, the amount of boron nitride present in the composition is ineffective to increase the extrusion rate to make the article.

What is claimed is:

1. An insulated wire, the insulation of which is unfoamed and extrusion coated on said wire, said insulation comprising a composition of hydrofluorocarbon polymer containing about 0.05 to 1.0 wt % of boron nitride based on the combined weight of said polymer and said boron nitride for improving the scrape abrasion resistance of said coating of said composition on said wire, said amount being ineffective to increase the rate of said extrusion to form said coating and said hydrofluorocarbon polymer is selected from the group consisting of ethylene/tetrafluoroethylene (ETFE), polyvinylidene fluoride (PVDF) and ethylene/chlorotrifluoroethylene (ECTFE).

2. The insulated wire of claim 1, wherein said hydrofluorocarbon polymer contains about 0.05 wt % to 0.5 wt % of boron nitride based on the combined weight of said polymer and said boron nitride.

3. The insulated wire of claim 1, wherein said hydrofluorocarbon polymer is ethylene/tetrafluoroethylene copolymer that has a melt flow rate of from about 25 g/10 min to about 35 g/10 min.

4. The insulated wire of claim 1, wherein said insulation is no greater than 0.15 mm thick.

5. The insulated wire of claim 1, wherein the improvement in scrape abrasion resistance is characterized by resisting at least 200 scrape abrasion cycles when subjected to ISO 6722 scrape abrasion testing at a load of 7 N.

6. An unfoamed melt-fabricated article comprised of hydrofluorocarbon polymer containing about 0.05 to 1.0 wt % of boron nitride based on the combined weight of said polymer and said boron nitride for improving the scrape abrasion resistance of said article, said amount being ineffective to increase the rate of said extrusion to form said article if formed by extrusion and said hydrofluorocarbon polymer is selected from the group consisting of ethylene/tetrafluoroethylene (ETFE), polyvinylidene fluoride (PVDF) and ethylene/chlorotrifluoroethylene (ECTFE).

7. The unfoamed melt-fabricated article of claim 6, wherein said hydrofluorocarbon polymer contains about 0.05 wt % to 0.5 wt % of boron nitride based on the combined weight of said polymer and said boron nitride.

8. Process comprising melt fabricating an article comprising hydrofluorocarbon polymer containing about 0.05 to 1.0 wt % of boron nitride based on the combined weight of said polymer and said boron nitride for improving the scrape abrasion resistance of said article, with the proviso that when said melt fabricating is extruding, the amount of said boron nitride is ineffective to increase the rate of said extruding to form said article and said hydrofluorocarbon polymer is selected from the group consisting of ethylene/tetrafluoroethylene (ETFE), polyvinylidene fluoride (PVDF) and ethylene/chlorotrifluoroethylene (ECTFE).

9. Process of claim 8, wherein said hydrofluorocarbon polymer contains about 0.05 wt % to 0.5 wt % of boron nitride based on the combined weight of said polymer and said boron nitride.

10. Process of claim 8, wherein said melt fabricating is extruding.

11. Process of claim 8, wherein said hydrofluorocarbon polymer is ethylene/tetrafluoroethylene copolymer that has a melt flow rate of from about 25 g/10 min to about 35 g/10 min.
